(19) United States
(12) Patent Application Publication
(10) Pub. No.: US 2018/0003265 A1
(43) Pub. Date: Jan. 4, 2018

(54) ROTARY MOP WITH DURABLE GEAR DRIVE UNIT

(71) Applicant: HONORS Co., Ltd., Ansan-si (KR)

(72) Inventor: Chul-Hwa JUNG, Incheon (KR)

(73) Assignee: HONORS Co., Ltd., Ansan-si (KR)

(21) Appl. No.: 15/200,486

(22) Filed: Jul. 1, 2016

(51) Int. Cl. F16H 1/16; F16H 57/031; A47L 11/40; F16H 57/04; A47L 11/282

(52) U.S. Cl. CPC F16H 1/16; F16H 57/0498; F16H 57/0424; A47L 11/282; A47L 11/4069; A47L 11/4038; F16H 57/031

(57) ABSTRACT

Disclosed is a rotary mop with a gear drive unit according to the present invention. The gear drive unit includes: a lower bearing supporting a rotary shaft by being fitted over a lower end of the rotary shaft; and a first packing unit having a skirt-shaped wing coming into contact with at least an outer race of the lower bearing, and being seated on a lower surface of a worm wheel, in which the first packing unit prevents lubricant for a worm and a worm wheel, or a foreign substance from being introduced into the lower bearing.

### BACKGROUND OF THE INVENTION

### Field of the Invention

The present invention relates generally to a gear drive unit including a worm gear, and a rotary mop with the gear drive unit. More particularly, the present invention relates to a rotary mop with the gear drive unit in which the gear drive unit is improved in durability.

### Description of the Related Art

A rotary mop using a rotary cloth that may clean a floor or other surfaces is disclosed in Korean Patent No. 1065569 (filed on Oct. 1, 2008 and registered on Sep. 8, 2011 by the inventor of the present invention), and Korean Patent No. 956737 (filed on Jul. 8, 2009 and registered on Apr. 29, 2010 by the inventor of the present invention).

Generally, according to the rotary mop in the related art, a rotational force generated from a motor is transmitted to a rotary plate, to which a rotary cloth formed in a circular shape is attached, by using a gear drive unit including a worm gear. In this case, the rotational force of a drive shaft of the motor is transmitted to a vertical rotary shaft coupled to the rotary plate by changing a direction of the rotational force by an angle of 90°.

However, according to the rotary mop in the related art, it is problematic in that a mechanism for supplying lubricant for a worm gear does not exist in the rotary mop, or an auxiliary worm wheel should be separately provided in the rotary mop in addition to a worm wheel coupled to a rotary shaft so as to stabilize an operation of a worm gear.

Therefore, according to the rotary mop in the related art, it is problematic in that there is a lack of durability of the rotary mop, or a drive load of the auxiliary worm wheel is added to the rotary mop.

### DOCUMENTS OF RELATED ART

(Patent Document 1) Korean Patent No. 1065569 (Registered on Sep. 8, 2011)
(Patent Document 2) Korean Patent No. 956737 (Registered on Apr. 29, 2010)

### SUMMARY OF THE INVENTION

Accordingly, the present invention has been made keeping in mind the above problems occurring in the related art, and the present invention is intended to propose a rotary mop that is considerably improved in durability without adding a drive load to the rotary mop.

In order to achieve the above object, according to one aspect of the present invention, there is provided a rotary mop with a durable gear drive unit, the mop including: a gear drive unit transmitting a driving force of a drive motor to a rotary cloth, the gear drive unit including: a worm coupled to a drive shaft of the drive motor; a worm wheel meshing with the worm; a rotary shaft coupled to the worm wheel along an axis of the worm wheel in a state of being perpendicular to the drive shaft; a lower bearing supporting the rotary shaft by being fitted over a lower end of the rotary shaft; and a first packing unit having a skirt-shaped wing coming into contact with at least an outer race of the lower bearing, and being seated on a lower surface of the worm wheel, in which the first packing unit prevents lubricant for the worm and the worm wheel, or a foreign substance from being introduced into the lower bearing.

In the mop, the gear drive unit may further include: an upper bearing fitted over an upper end of the rotary shaft; and a second packing unit having a skirt-shaped wing coming into contact with at least an outer race of the upper bearing, and being seated on an upper surface of the worm wheel, in which the second packing unit may prevent lubricant for the worm and the worm wheel, or a foreign substance from being introduced into the upper bearing.

In the mop, the first packing unit may further include: a ring-shaped portion; and a plurality of protrusions formed on a first surface of the ring-shaped portion along a circumferential direction of the ring-shaped portion, in which the skirt-shaped wing may extend from a second surface of the ring-shaped portion, and be continuously formed along the circumferential direction, and the second surface is opposite to the first surface.

In the mop, a plurality of recesses may be formed on the lower surface of the worm wheel along a circumferential direction of the worm wheel, and the plurality of protrusions may be seated in the plurality of recesses, respectively.

In the mop, the gear drive unit may further include: an upper cover and a lower cover that accommodate a free end of the drive shaft and the worm wheel, the lower cover including a guide hole allowing the lower end of the rotary shaft to extend outside the lower cover.

In the mop, the drive shaft may be supported by a drive shaft bearing interposed between a first semicylindrical portion of the upper cover and a second semicylindrical portion of the lower cover.

In the mop, the upper cover may include: a first accommodation groove formed in a semicylindrical shape, and configured to straightly extend from a first edge of the upper cover to an inner area thereof so as to accommodate the free end of the drive shaft; a first semicylindrical portion formed on an outer circumferential surface of the first accommodation groove; a first worm wheel accommodation space defined in a state of being overlapped with a distal end of the first accommodation groove; and an upper bearing seat formed in an inner area of the first worm wheel accommodation space, and the lower cover formed in a shape corresponding to a shape of the upper cover, the lower cover including: a second accommodation groove formed in a semicylindrical shape, and configured to straightly extend from a first edge of the lower cover to an inner area thereof so as to accommodate the free end of the drive shaft; a second semicylindrical portion formed on an outer circumferential surface of the second accommodation groove; a second worm wheel accommodation space defined in a state of being overlapped with a distal end of the second accommodation groove; a lower bearing seat formed in an inner area of the second worm wheel accommodation space; and the guide hole formed in a center of the lower bearing seat.

In the mop, an oil hole may be formed in the upper cover, the oil hole being located at a position corresponding to a position of an upper portion of the worm.

In the mop, the gear drive unit may further include: a cup-shaped unit made of rubber interposed between the upper bearing seat and an upper bearing; and a cup-shaped unit made of rubber interposed between the lower bearing seat and the lower bearing.

In the mop, the first and second packing units may be made of rubber.

The features and advantages of the present invention will be more clearly understood from the following detailed description in conjunction with the accompanying drawings.

Prior to this, all terms used herein should not be conventionally interpreted as those defined in commonly used dictionaries, but should be interpreted as the meaning and concept corresponding to the technical spirit of the present invention in the principle that the inventor may appropriately define the meaning of the terms so as to explain the invention in the best way.

According to the present invention, it is advantageous as follows. The present invention can prevent lubricant for a worm gear and/or a foreign substance from being introduced into upper and lower bearings while the upper and lower bearings support a rotary shaft of a worm gear of a rotary mop. Accordingly, the present invention can stabilize an operation of a gear drive unit including a worm gear, and improve durability thereof.

The present invention can minimize loss of a rotational force in such a way that lubricant for a worm gear is smoothly supplied to the worm gear of the rotary mop while the present invention can stabilize an operation of the gear drive unit including a worm gear, and improve durability thereof.

The rotary mop according to the present invention can reduce noise and vibration thereof, and can more stably rotate rotary cloths when the rotary mop is operated.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view of a rotary mop according to an embodiment of the present invention;

FIG. 2 is a perspective view schematically illustrating a body of the mop of FIG. 1 in a state where a covering member is removed from the body;

FIG. 3 is an exploded perspective view schematically illustrating the body of FIG. 2;

FIG. 4 is an exploded perspective view schematically illustrating a gear drive unit according to the embodiment of the present invention;

FIG. 5A is a view schematically illustrating the inner side surface of an upper cover of FIG. 4;

FIG. 5B is a view schematically illustrating the inner side surface of a lower cover of FIG. 4;

FIGS. 6A and 6B are front views illustrating a worm wheel, first and second packing units, and a lower bearing according to the embodiment of the present invention; and

FIG. 7 is an exploded perspective view of the worm wheel and the first and second packing units of FIGS. 6A and 6B.

### DETAILED DESCRIPTION OF THE INVENTION

Hereinbelow, a gear drive unit including a worm gear and a rotary mop with the gear drive unit according to the present invention will be described in detail with reference to the accompanying drawings.

The advantages and features of the present invention, and the ways to achieve them will be clearly understood from the following embodiments in conjunction with the accompanying drawings. The same reference symbols will be used to denote the same or like components throughout the specification. Furthermore, when specific descriptions of the related art make the subject matter of the present invention unclear, the specific descriptions of the related art will be omitted.

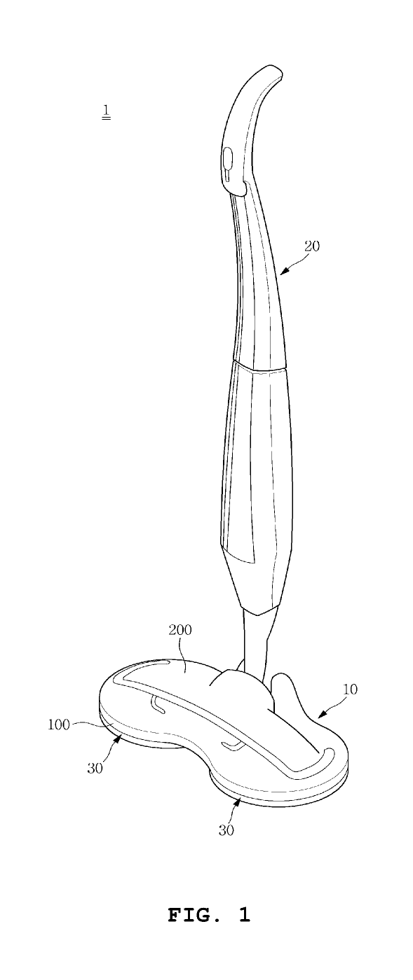

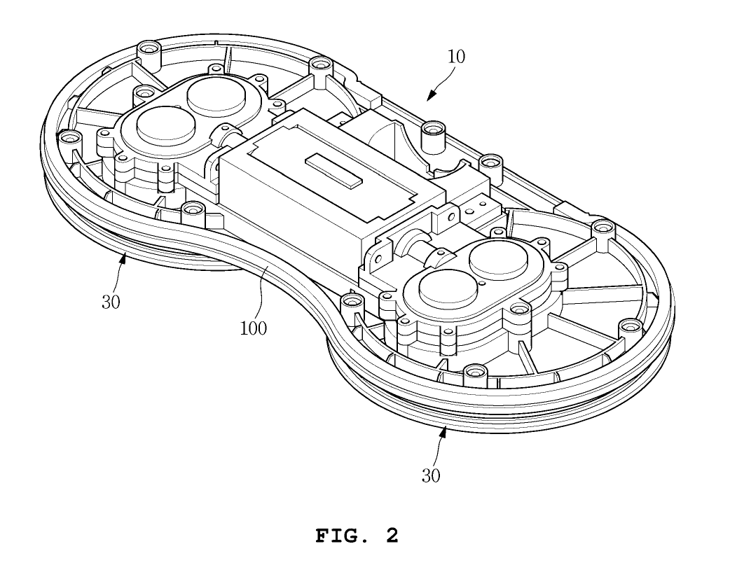

Referring to FIGS. 1 to 3, the present invention relates to a rotary mop 1 with a pair of rotary cloths. The mop 1 includes: a body 10 including a gear drive unit 300; a stick 20 coupled to the body 10; and a pair of rotary cloth plates 30 disposed on a lower surface of the body 10, and configured to rotate by being coupled to respective lower ends of respective rotary shafts of the gear drive unit 300. Further, a driving force of the drive motor 310 is transmitted to the pair of rotary cloths attached to or detached from the respective rotary cloth plates 30.

The mop 1 according to an embodiment of the present invention may clean a floor in such a way that the pair of rotary cloth plates 30 rotate. Thus, the gear drive unit 300 including a worm gear is provided in the body 10 of the mop 1 so as to rotate the pair of rotary cloth plates 30.

The body 10 is rotatably coupled to the stick 20, and helps the pair of rotary cloth plates 30 rotate. Further, the stick 20 is rotatably coupled to the body 10 in front/rear and left/right directions within a predetermined angle range. In this case, since methods of coupling a stick to a body are already known to those skilled in the art and are not directly related to the subject matter of the present invention, detailed descriptions of the methods of coupling a stick to a body are omitted.

The body 10 includes a base 100, a covering member 200, and the gear drive unit 300. A space to accommodate the gear drive unit 300 is provided in the base 100. As shown in FIGS. 1 to 3, the pair of rotary cloth plates 30 may be rotatably disposed on a lower surface of the base 100.

In the body 10, an upper portion of the base 100 is covered with the covering member 200, and an inner space defined by the base 100 and the covering member 200 accommodates the gear drive unit 300. The covering member 200 is detachably coupled to the base 100.

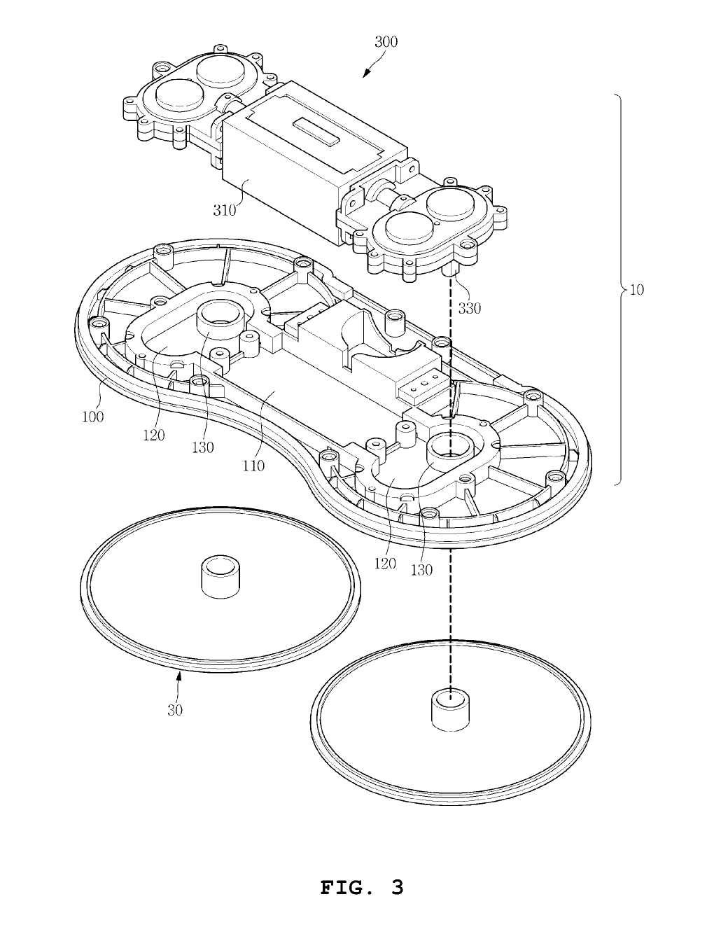

As shown in FIG. 3, a seat 110 fixing the drive motor 310 thereto is formed in the middle of an inner area of the base 100, and gear box seats 120 are symmetrically formed based on the seat 110 in the inner area of the base 100. The gear box seats 120 fix respective worm gear boxes (no reference symbol) disposed on opposite sides of the gear drive unit 300, and have respective holes 130 formed therethrough. The holes 130 allow the respective rotary shafts 330 downwardly extending from the gear drive unit 300 disposed on an upper surface of the base 100 to penetrate the lower surface of the base 100.

Hereinafter, when any components, such as the worm gear boxes, parts of the worm gear boxes, the rotary cloth plates, the rotary cloths, and the like, are provided on the opposite sides of the drive motor according to the present invention, and the components have the same structure, only a single component may be described, unless otherwise specified.

The lower end of the rotary shaft 330 penetrating the lower surface of the base 100 is detachably coupled to the rotary cloth plate 30 disposed on the lower surface of the base 100. The rotary cloth plate 30 shown in FIGS. 1 to 3 is formed in a disc shape, and the rotary cloth (not shown) may be easily attached to or detached from a lower surface of the rotary cloth plate 30 via Velcro. The pair of rotary cloths may clean a floor of a room by rotating in a state of coming into contact with the floor of a room.

In the present invention, the gear drive unit 300 including a worm gear is installed on the upper surface of the base 100. Further, the worm gear box is disposed around a free end of a drive shaft 311 and beside the drive motor 310 seated on the seat 110 of the base 100. In this case, the worm gear box is a gear device transmitting rotation between two shafts (for example, between the drive shaft and the rotary shaft) and includes an upper cover 340, a lower cover 350, and bearings 361, 364, and 365. The upper and lower covers 340 and 350 may be fixed to the base 100 via bolts.

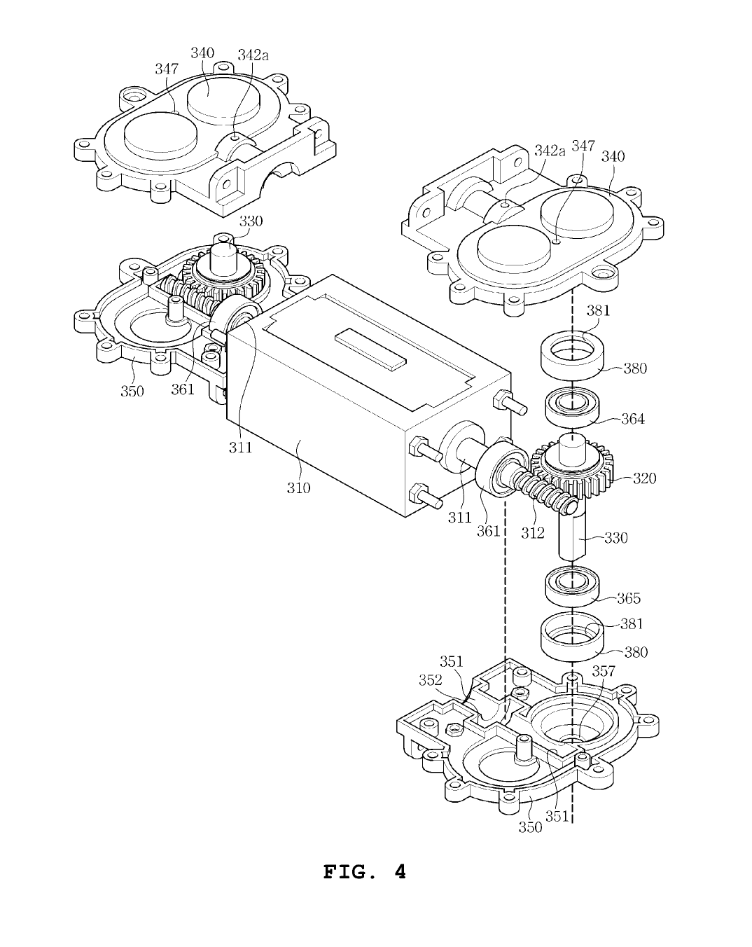

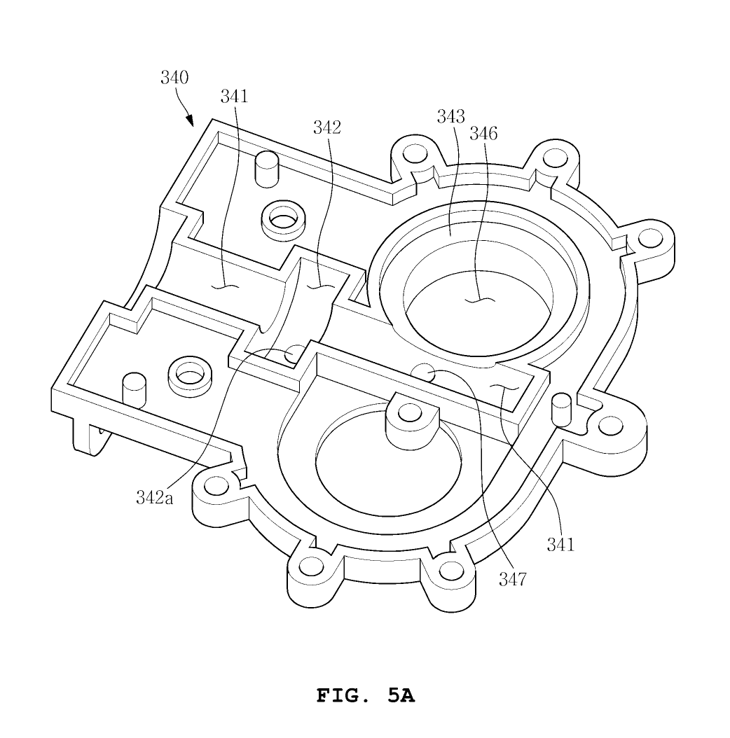

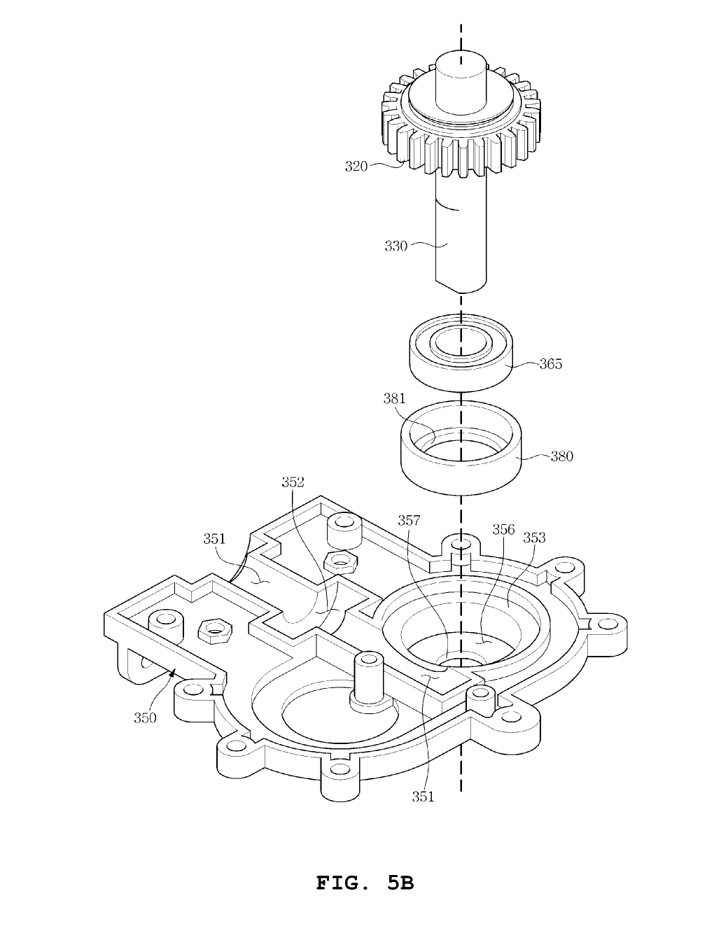

Referring to FIGS. 4, 5A, and 5B, the gear drive unit 300 includes: the drive motor 310 disposed in the middle of the upper surface of the base 100 (shown in FIG. 3); the drive shaft 311 longitudinally extending from the side of the drive motor 310; a worm 312 coupled to the free end of the drive shaft 311; a worm wheel 320 meshing with the worm 312; and the rotary shaft 330 vertically disposed on the center of the worm wheel 320.

The drive motor 310 rotates the drive shafts 311 by using external power. Further, as shown in FIG. 4, the drive shafts 311 may longitudinally extend from the respective opposite sides of the drive motor 310.

Furthermore, the spirally threaded worm 312 is coupled to the drive shaft 311, and thus the spirally threaded worm 312 is formed on an outer circumferential surface of the free end of the drive shaft 311. The gear drive unit 300 is configured such that the drive shaft 311 may transmit a rotational force to the rotary shaft 330 via the worm wheel 320 meshing with the spirally threaded worm 312 in a state where the drive shaft 311 is perpendicular to the rotary shaft 330. Tooth-shape protrusions are formed on an outer circumferential surface of the worm wheel 320 so that the worm wheel 320 may mesh with the spirally threaded worm 312. Further, the rotary shaft 330 is coupled to the worm wheel along the axis of the worm wheel 320. An upper end of the rotary shaft 330 protrudes from an upper surface of the worm wheel, and the lower end of the rotary shaft 330 protrudes from a lower surface of the worm wheel. The lower end of the rotary shaft 330 extends to a position below the lower surface of the base 100 through the lower cover 350 and the hole 130 of the base 100.

In the mop according to the embodiment of the present invention, spiral threads of the worm of the left drive shaft 311 and spiral threads of the worm of the right drive shaft 311 may be oppositely formed to oppositely rotate the pair of rotary cloths, i.e., the pair of rotary cloth plates 30. That is, since the spiral threads of the respective worms 312 are oppositely formed, the pair of rotary cloth plates 30 that belong to the respective drive shafts 311 may oppositely rotate. In this case, when the pair of rotary cloth plates 30 utilized in the mop rotate in the same direction, the pair of rotary cloth plates 30 may be moved toward the rotational direction of the pair of rotary cloth plates 30. However, when the pair of rotary cloth plates 30 oppositely rotate, the pair of rotary cloth plates 30 may be prevented from being moved toward a single rotational direction of the pair of rotary cloth plates 30.

In addition, a double shaft motor having a pair of drive shafts may be utilized as the drive motor 310, or two drive motors having respective drive shafts may be utilized by arranging the two drive motors in a row as the drive motor 310, but the present invention is not limited thereto.

The upper cover 340 includes: a first accommodation groove 341 formed in a semicylindrical shape, and configured to straightly extend from a first edge of the upper cover 340 to an inner area of the upper cover 340; a first semicylindrical portion 342 formed on an outer circumferential surface of the first accommodation groove, and configured to have a larger diameter than that of the first accommodation groove; a first circular worm wheel accommodation space 343 defined in a state of being overlapped with a distal end of the first accommodation groove 341; and an upper bearing seat 346 formed in an inner area of the first worm wheel accommodation space 343. The first accommodation groove 341 guides the free end of the drive shaft 311 to an inner area of the upper cover 340. Meanwhile, the first semicylindrical portion 342 may support and hold a drive shaft bearing 361 coupled to the drive shaft 311 along the axis of the drive shaft 311. The drive shaft bearing 361 fixes the drive shaft 311 to a right position, and rotatably supports the drive shaft 311. Furthermore, the first worm wheel accommodation space 343 formed in a cylindrical shape accommodates an upper portion of the worm wheel, and an outer circumference of the first worm wheel accommodation space 343 is disposed in a state of being overlapped with the first accommodation groove 341. Thus, the worm 312 of the drive shaft 311 that is guided to the first accommodation groove 341 may securely mesh with the worm wheel 320. The upper bearing seat 346 is bulbously formed upward in the inner area of the first worm wheel accommodation space 343. Further, the upper bearing seat 346 has a smaller diameter than that of the first worm wheel accommodation space 343, and is disposed along the axis of the first worm wheel accommodation space 343.

Selectively, the upper cover 340 may include a window 342a communicating with the first semicylindrical portion 342. While the drive shaft 311 is driven, heat generated from the drive shaft bearing 361 disposed in the first semicylindrical portion 342 may be radiated to the outside via the window 342a. Further, oil for the drive shaft bearing 361 may be injected via the window 342a, and a condition of the drive shaft bearing 361 may be inspected with the naked eye.

The upper cover 340 includes an oil hole 347, and the oil hole 347 is located in a position above the worm 312 of the drive shaft 311. The oil hole 347 is a passage for supplying lubricant to a worm gear of the gear drive unit 300. When the lubricant for a gear is supplied to an upper portion of the worm 312, the lubricant is moved in a direction opposite to the drive motor in such a way that the spiral threads of the worm 312 rotate.

Since the drive shaft bearing 361 is provided between the worm 312 of the drive shaft 311 and the drive motor 310, the drive shaft bearing 361 is prevented from coming into contact with the lubricant moving in a direction opposite to the drive motor.

The lower cover 350 is formed in a shape corresponding to a shape of the upper cover 340. The lower cover 350 includes: a second accommodation groove 351 formed in a semicylindrical shape, and configured to straightly extend from a first edge of the lower cover 350 to an inner area of the lower cover 350; a second semicylindrical portion 352 formed on an outer circumferential surface of the second accommodation groove 351, and configured to have a larger diameter than that of the second accommodation groove 351; a second circular worm wheel accommodation space 353 defined in a state of being overlapped with a distal end of the second accommodation groove 351; a lower bearing seat 356 formed in an inner area of the second worm wheel accommodation space 353; and a guide hole 357 formed in the center of the lower bearing seat 356. The second accommodation groove 351 guides the free end of the drive shaft 311 to the inner area of the lower cover. Meanwhile, the second semicylindrical portion 352 may support and hold the drive shaft bearing 361 coupled to the drive shaft 311 along the axis of the drive shaft 311. Furthermore, the second worm wheel accommodation space 353 formed in a cylindrical shape accommodates a lower portion of the worm wheel, and an outer circumference of the second worm wheel accommodation space 353 is disposed in a state of being overlapped with the second accommodation groove 351. Thus, the worm 312 of the drive shaft 311 that is guided to the second accommodation grooves 351 may securely mesh with the worm wheel 320. The lower bearing seat 356 is bulbously formed downward in the inner area of the second worm wheel accommodation space 353. Further, the lower bearing seat 356 has a smaller diameter than that of the second worm wheel accommodation space 353, and is disposed along the axis of the second worm wheel accommodation space 353. Furthermore, the guide hole 357 having a smaller diameter than those of the second semicylindrical portion 352 and the lower bearing seat 356 guides the rotary shaft 330 coupled to the worm wheel 320 to the outside, and the guide hole 357 is disposed along the axis of the lower bearing seat 356.

As described, the upper bearing 364 is disposed in the upper bearing seat 346 of the upper cover 340, and the lower bearing 365 is disposed in the lower bearing seat 356 of the lower cover 350.

The rotary shaft 330 is coupled to the worm wheel 320 along the axis of the worm wheel 320. In this case, the upper end of the rotary shaft 330 is supported by the upper bearing 364 in such a way that the upper bearing 364 is fitted over the upper end of the rotary shaft 330, and the lower end of the rotary shaft 330 is supported by the lower bearing 365 in such a way that the lower bearing 365 is fitted over the lower end of the rotary shaft 330. The rotary shaft 330 is rotatably installed through the worm wheel 320 by using the upper and lower bearings 364 and 365 that are fitted over the respective upper and lower ends of the rotary shaft 330 in a state of being perpendicular to the drive shaft.

Furthermore, a cup-shaped unit 380 is interposed between the upper bearing seat 346 and the upper bearing 364, and a cup-shaped unit 380 is interposed between the lower bearing seat 356 and the lower bearing 365. The cup-shaped units 380 may be made of a rubber material, and thus may prevent lubricant for a gear from permeating into a gap between the lower cover and the lower bearing, or a gap between the upper cover and the upper bearing. Further, the cup-shaped units 380 may prevent the upper and lower bearings 364 and 365 from rotating together with the rotary shaft 330. In addition, the upper and lower bearings 364 and 365 may be prevented from escaping from the upper and lower bearing seats 346 and 356 in such a way that the cup-shaped units 380 help the upper and lower bearings 364 and 365 to be fixed to the upper and lower bearing seats 346 and 356.

As shown in FIGS. 4 and 5B, the cup-shaped units 380 may have penetration paths for the rotary shaft in such a way as to have hollows 381 formed therein.

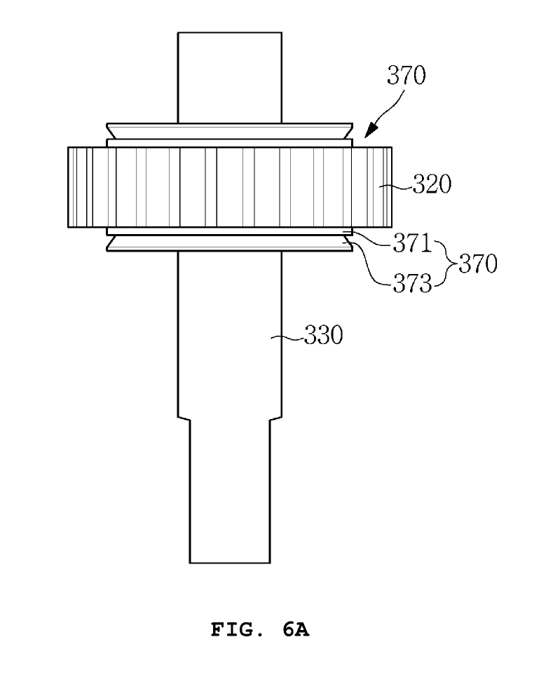

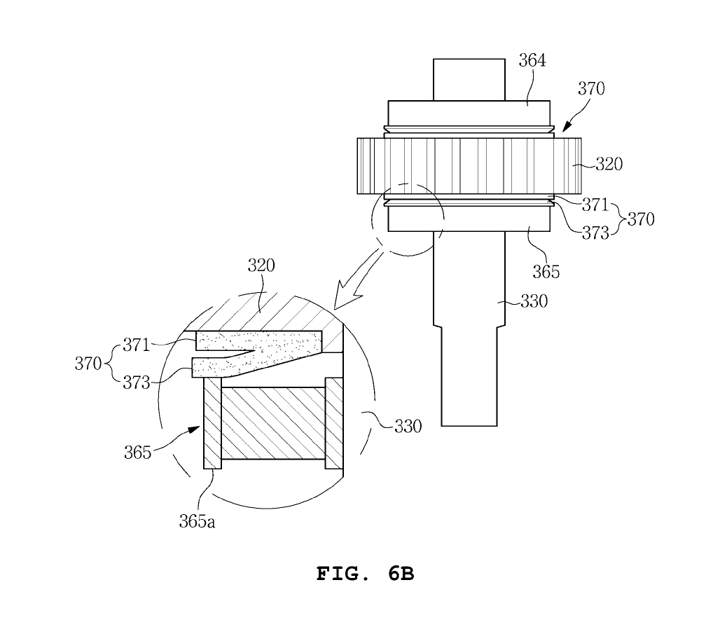

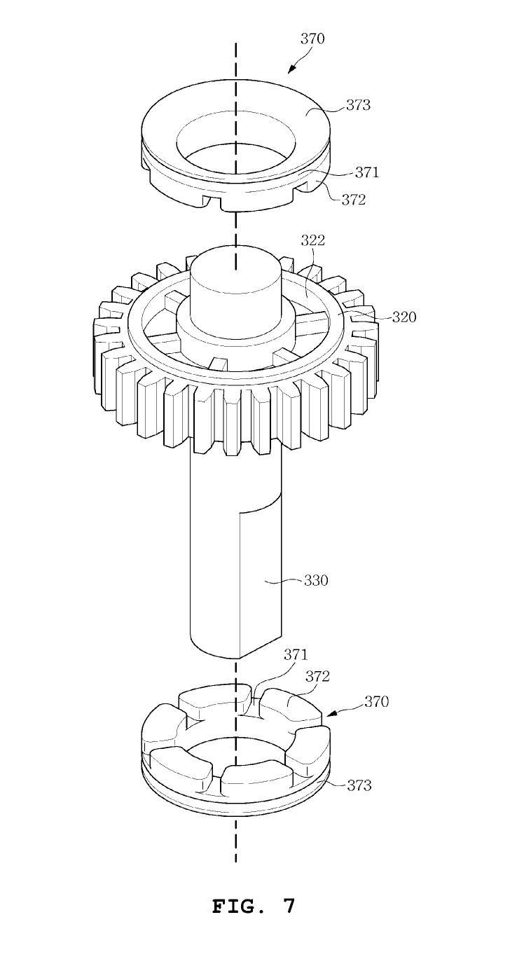

As shown in FIGS. 6A, 6B, and 7, in the mop according to the present invention, a direction of a driving force may be changed by using the gear drive unit including a worm gear while height of the body 10 of the mop is lowered.

The worm 312 is provided on the drive shaft 311, and the worm wheel 320 is provided on an outer circumference of the rotary shaft 330 so that a driving force is transmitted to the rotary shaft 330 disposed in a state of being perpendicular to the drive shaft 311 (shown in FIG. 4). Furthermore, the first and second packing units 370 formed in a ring shape are provided on the respective lower and upper surfaces of the worm wheel 320.

The rotary shaft 330 may be inserted into the first and second packing units 370. Further, each of the first and second packing units 370 includes: a ring-shaped portion 371; a plurality of protrusions 372 formed on a first surface of the ring-shaped portion 371 along a circumferential direction of the ring-shaped portion 371; and the skirt-shaped wing 373 extending from a second surface of the ring-shaped portion 371, and being continuously formed along the circumferential direction of the ring-shaped portion 371 such that the second surface of the ring-shaped portion 371 is opposite to the first surface of the ring-shaped portion 371.

In this case, a plurality of recesses 322 is formed on each of the upper and lower surfaces of the worm wheel 320 along a circumferential direction of the worm wheel 320, and the plurality of protrusions 372 of each of the first and second packing units 370 is seated in the plurality of recesses 322, respectively, so that the first and second packing units 370 are fixed to the lower and upper surfaces of the worm wheel 320. Further, the plurality of recesses 322 formed in a shape to accommodate the respective plurality of protrusions 372.

The first and second packing units 370 may be seated on the lower and upper surfaces of the worm wheel 320, respectively, in such a way that the pluralities of protrusions 372 of the first and second packing units 370 are fitted into the pluralities of recesses 322 formed on the lower and upper surfaces of the worm wheel 320. Thus, the first and second packing units 370 may be prevented from escaping from the worm wheel 320 that rotates.

Especially, in each of the first and second packing units 370, the skirt-shaped wing 373 with a hollow formed therein is formed on the second surface of the ring-shaped portion 371 such that the second surface of the ring-shaped portion 371 is opposite to the first surface of the ring-shaped portion 371 on which the plurality of protrusions 372 is formed. As described, the skirt-shaped wing 373 extends from the second surface of the ring-shaped portion 371 in such way that a small diameter portion of the skirt-shaped wing 373 is integrally coupled to the second surface of the ring-shaped portion 371. Further, a large diameter portion of the skirt-shaped wing 373 is spaced apart from an outer circumferential end of the ring-shaped portion 371.

When the first and second packing units 370 are seated on the respective lower and upper surfaces of the worm wheel 320 and the lower and upper bearings slightly press the respective first and second packing units 370 by coupling the upper and lower covers to each other, the extent of spreading the skirt-shaped wing 373 (for example, an spread angle of the skirt-shaped wing 373) in each of the first and second packing units 370 is increased. Thus, a contact force and a contact area between the skirt-shaped wing 373 of each of the first and second packing units 370 and each of the upper and lower bearings (an outer race of each of the upper and lower bearings) are also increased.

In each of the first and second packing units 370, it is ensured that an inclined plane between the small and large diameter portions of the skirt-shaped wing 373 with a hollow formed therein comes into contact with each of the lower and upper bearings 365 and 364. Especially, it is ensured that the skirt-shaped wing 373 of each of the first and second packing units 370 comes into contact with the outer race 365a of each of the lower and upper bearings 365 and 364 (shown in a partially exploded view of FIG. 6B).

The skirt-shaped wings 373 of the respective first and second packing units 370 come into contact with the outer races of the respective lower and upper bearings 365 and 364. Thus, lubricant for the worm 312 and the worm wheel 320, and/or a foreign substance may be prevented from being introduced into the lower and upper bearings 365 and 364.

According to the present invention, oil mixing between lubricant for a gear that is injected into the worm gear and oil for a bearing that is supplied to the lower and upper bearings 365 and 364 is prevented. In this case, since the lubricant for a gear and the oil for a bearing are different from each other, when the lubricant for a gear is injected into the lower and upper bearings 365 and 364, operation and lifetime of the lower and upper bearings 365 and 364 may be negatively influenced.

Furthermore, tiny impurities occurring due to long-term operation of the mop and the worm gear may be introduced into the lower and upper bearings 365 and 364 via lubricant for a gear. Accordingly, lifetime and rotational performance of the lower and upper bearings 365 and 364 may be negatively influenced. Thus, according to the present invention, the tiny impurities may be prevented by using the skirt-shaped wings 373 of the respective first and second packing units 370.

An oil-tight structure is utilized in the gear drive unit according to the present invention so that lubricant for a gear may be prevented from being introduced into the drive shaft bearing, and the upper and lower bearings.

Preferably, the first and second packing units 370 are made of an elastic material, for example, rubber. In general, a rubber material is not appropriate for rotary members rotating by coming into contact with each other since a rubber material has high coefficient of friction. However, since lubricant for a gear or oil for a bearing is applied to inclined planes of the respective skirt-shaped wings 373 coming into contact with the respective lower and upper bearings, the extent of disturbing rotation of the worm wheel 320 is insignificant.

Although a preferred embodiment of the present invention has been described for illustrative purposes, the gear drive unit including a worm gear and the rotary mop with the gear drive unit according to the present invention are not limited thereto, and it should be understood that the gear drive unit including a worm gear and the rotary mop with the gear drive unit can be variously modified in many different forms by those skilled in the art within the scope and spirit of the present invention.

In addition, it should be understood that various modifications, additions and substitutions of the present invention are possible, without departing from the scope and spirit of the present invention, and the scope and spirit of the present invention are clearly defined by the accompanying claims.

What is claimed is:

1. A rotary mop with a durable gear drive unit, the mop comprising:
a gear drive unit transmitting a driving force of a drive motor to a rotary cloth, the gear drive unit including:
a worm coupled to a drive shaft of the drive motor;
a worm wheel meshing with the worm;
a rotary shaft coupled to the worm wheel along an axis of the worm wheel in a state of being perpendicular to the drive shaft;
a lower bearing supporting the rotary shaft by being fitted over a lower end of the rotary shaft; and
a first packing unit having a skirt-shaped wing coming into contact with at least an outer race of the lower bearing, and being seated on a lower surface of the worm wheel,
wherein the first packing unit prevents lubricant for the worm and the worm wheel, or a foreign substance from being introduced into the lower bearing.

2. The mop of claim 1, wherein the gear drive unit further includes:
an upper bearing fitted over an upper end of the rotary shaft; and
a second packing unit having a skirt-shaped wing coming into contact with at least an outer race of the upper bearing, and being seated on an upper surface of the worm wheel,
wherein the second packing unit prevents lubricant for the worm and the worm wheel, or a foreign substance from being introduced into the upper bearing.

3. The mop of claim 1, wherein the first packing unit further includes:
a ring-shaped portion; and
a plurality of protrusions formed on a first surface of the ring-shaped portion along a circumferential direction of the ring-shaped portion,
wherein the skirt-shaped wing extends from a second surface of the ring-shaped portion, and is continuously formed along the circumferential direction, and the second surface is opposite to the first surface.

4. The mop of claim 3, wherein a plurality of recesses is formed on the lower surface of the worm wheel along a circumferential direction of the worm wheel, and the plurality of protrusions is seated in the plurality of recesses, respectively.

5. The mop of claim 1, wherein the gear drive unit further includes:
an upper cover and a lower cover that accommodate a free end of the drive shaft and the worm wheel, the lower cover including a guide hole allowing the lower end of the rotary shaft to extend outside the lower cover.

6. The mop of claim 5, wherein the drive shaft is supported by a drive shaft bearing interposed between a first semicylindrical portion of the upper cover and a second semicylindrical portion of the lower cover.

7. The mop of claim 5, wherein the upper cover includes:
a first accommodation groove formed in a semicylindrical shape, and configured to straightly extend from a first edge of the upper cover to an inner area thereof so as to accommodate the free end of the drive shaft;
a first semicylindrical portion formed on an outer circumferential surface of the first accommodation groove;
a first worm wheel accommodation space defined in a state of being overlapped with a distal end of the first accommodation groove; and
an upper bearing seat formed in an inner area of the first worm wheel accommodation space, and
the lower cover formed in a shape corresponding to a shape of the upper cover, the lower cover including:
a second accommodation groove formed in a semicylindrical shape, and configured to straightly extend from a first edge of the lower cover to an inner area thereof so as to accommodate the free end of the drive shaft;
a second semicylindrical portion formed on an outer circumferential surface of the second accommodation groove;
a second worm wheel accommodation space defined in a state of being overlapped with a distal end of the second accommodation groove;
a lower bearing seat formed in an inner area of the second worm wheel accommodation space; and
the guide hole formed in a center of the lower bearing seat.

8. The mop of claim 7, wherein an oil hole is formed in the upper cover, the oil hole being located at a position corresponding to a position of an upper portion of the worm.

9. The mop of claim 7, wherein the gear drive unit further includes:
a cup-shaped unit made of rubber interposed between the upper bearing seat and an upper bearing; and
a cup-shaped unit made of rubber interposed between the lower bearing seat and the lower bearing.

10. The mop of claim 2, wherein the first and second packing units are made of rubber.
